(19) United States
(12) Patent Application Publication
(10) Pub. No.: US 2025/0317759 A1
(43) Pub. Date: Oct. 9, 2025

(54) APPARATUS AND METHOD FOR INTEGRATED INFERENCE USING DUAL-SIDED MACHINE LEARNING IN WIRELESS COMMUNICATION SYSTEM

(71) Applicant: Electronics and Telecommunications Research Institute, Daejeon (KR)

(72) Inventors: Anseok LEE, Daejeon (KR); Yong Jin KWON, Daejeon (KR); Seungjae BAHNG, Daejeon (KR); Youngjoon YOON, Daejeon (KR); Heesoo LEE, Daejeon (KR); Yunjoo KIM, Daejeon (KR); Hyun Seo PARK, Daejeon (KR); Jung Sook BAE, Daejeon (KR); Jungbo SON, Daejeon (KR); Yu Ro LEE, Daejeon (KR)

(21) Appl. No.: 19/171,138

(22) Filed: Apr. 4, 2025

(30) Foreign Application Priority Data
Apr. 5, 2024 (KR) 10-2024-0046593
Apr. 17, 2024 (KR) 10-2024-0051440
May 10, 2024 (KR) 10-2024-0061852
May 22, 2024 (KR) 10-2024-0066485
Mar. 24, 2025 (KR) 10-2025-0037343

(51) Int. Cl. H04W 24/02; H04L 41/16

(52) U.S. Cl. CPC H04W 24/02; H04L 41/16

(57) ABSTRACT

The present disclosure generally relates to wireless communication systems, and more particularly, to an apparatus and method for integrated inference using dual-sided machine learning in wireless communication systems. A method of operating a user equipment (UE) in a wireless communication system includes: transmitting capability information of the UE to a network; receiving at least one of a structure or parameters of a reference model, or receiving a learning data set from the network according to the capability information of the UE; configuring a machine learning (ML) model directly on the UE or through a UE-side learning server based 10 on the received information; and performing integrated inference based on dual-sided machine learning models with the network using the configured machine learning model.

### CROSS-REFERENCE TO RELATED APPLICATIONS

This application claims priority to Korean Patent Application No. 10-2024-0046593 filed on Apr. 5, 2024, Korean Patent Application No. 10-2024-0051440 filed on Apr. 17, 2024, Korean Patent Application No. 10-2024-0061852 filed on May 10, 2024, Korean Patent Application No. 10-2024-0066485 filed on May 22, 2024, and Korean Patent Application No. 10-2025-0037343 filed on Mar. 24, 2025, the entire contents of which are hereby incorporated by reference.

### BACKGROUND OF THE INVENTION

### Field of the Invention

The present disclosure generally relates to wireless communication systems, and more particularly, to an apparatus and method for integrated inference using dual-sided machine learning in wireless communication systems.

### Description of the Related Art

The International Telecommunication Union (ITU) has been developing frameworks and standards for International Mobile Telecommunication (IMT), and recently, a program called “IMT for 2030 and beyond” has initiated discussions for 6th generation (6G) communications.

Among the technologies for implementing 6G, Artificial Intelligence (AI) is receiving significant attention. The 3GPP has begun researching AI/ML technologies for the Air Interface in Release 18. The main use cases being studied by 3GPP include:
(1) AI/ML for CSI feedback enhancement
(2) AI/ML for beam management
(3) AI/ML for positioning performance enhancement

More specifically, in mobile communication networks, transmitters perform coding level, power allocation, and beamforming using multiple transmit antennas to transmit data to receivers. For this purpose, the transmitter needs to obtain information about the wireless channel between the transmitter and receiver antennas. However, since the transmitter cannot directly observe the channel from the transmitter to the receiver, a Channel State Information (CSI) reporting procedure is needed, in which the receiver measures channel information and reports it to the transmitter. CSI is information used by the transmitter to schedule data transmission to the receiver and includes rank, Channel Quality Index, and precoding information.

To measure channel states at the receiver, reference signals such as CSI-Reference Signal (CSI-RS) have been designed. The transmitter periodically or aperiodically transmits CSI-RS, and pre-configures transmission-related information so that the receiver can receive it. After the receiver receives the CSI-RS, it generates CSI and transmits it back to the transmitter in a CSI reporting procedure. To precisely represent channel information, the amount of information needs to be very large, which increases the occupation of wireless transmission resources and overhead, thereby reducing system performance.

To address this issue in mobile communication networks, research has begun on using Machine Learning (ML) technology to acquire channel state information at the transmitter with high accuracy while minimizing the amount of transmitted information. For dual-sided machine learning models for CSI feedback, inference is performed collaboratively by models that exist at both the user equipment (UE) and network. In this case, the machine learning models used for inference are constrained to operate in conjunction with each other. To satisfy this constraint, machine learning models at the UE and network sides must be integrated in a mutually compatible form, and three representative methods have been researched for this purpose:
(1) Centralized learning
(2) Distributed learning
(3) Sequential learning

Additionally, the UE and network must either have machine learning models pre-installed that correspond to each other, or receive and install them from the other device or a third-party device.

### SUMMARY OF THE INVENTION

Based on the above discussion, the present disclosure provides an apparatus and method for achieving high accuracy in CSI transmission using machine learning models in wireless communication systems.

The present disclosure also provides an apparatus and method for efficient CSI feedback through alignment of dual-sided machine learning models in wireless communication systems.

Furthermore, the present disclosure provides an apparatus and method for UEs or networks to efficiently share and manage machine learning models or learning data sets through a common server in wireless communication systems.

Additionally, the present disclosure provides an apparatus and method for selecting and acquiring optimized machine learning models that consider the processing capabilities and storage space of UEs in wireless communication systems.

Moreover, the present disclosure provides an apparatus and method for effectively acquiring reference models or data sets according to various joint learning methods for dual-sided machine learning models in wireless communication systems.

According to various embodiments of the present disclosure, a method of operating a user equipment (UE) in a wireless communication system includes: transmitting capability information of the UE to a network; receiving at least one of a structure or parameters of a reference model, or receiving a learning data set from the network according to the capability information of the UE; configuring a machine learning (ML) model directly on the UE or through a UE-side learning server based on the received information; and performing integrated inference based on dual-sided machine learning models with the network using the configured machine learning model.

According to various embodiments of the present disclosure, a method of operating a network in a wireless communication system includes: receiving capability information of a user equipment (UE) from the UE; transmitting at least one of a structure or parameters of a reference model, or transmitting a learning data set to the UE or a UE-side learning server according to the capability information of the UE; receiving machine learning model configuration completion information from the UE; and performing integrated inference based on dual-sided machine learning (ML) models with the UE.

According to various embodiments of the present disclosure, a user equipment (UE) in a wireless communication system includes: a transceiver; and a controller operably connected to the transceiver, wherein the controller is configured to transmit capability information of the UE to a network, receive at least one of a structure or parameters of a reference model, or receive a learning data set from the network according to the capability information of the UE, configure a machine learning (ML) model directly on the UE or through a UE-side learning server based on the received information, and perform integrated inference based on dual-sided machine learning models with the network using the configured machine learning model.

According to various embodiments of the present disclosure, a network in a wireless communication system includes: a transceiver; and a controller operably connected to the transceiver, wherein the controller is configured to receive capability information of a user equipment (UE) from the UE, transmit at least one of a structure or parameters of a reference model, or transmit a learning data set to the UE or a UE-side learning server according to the capability information of the UE, receive machine learning model configuration completion information from the UE, and perform integrated inference based on dual-sided machine learning (ML) models with the UE.

### BRIEF DESCRIPTION OF THE DRAWINGS

FIG. 1 illustrates a dual-sided machine learning model structure in a wireless communication system according to an embodiment of the present disclosure.

FIG. 2 illustrates a procedure for downloading an AI model or data set using a common server according to an embodiment of the present disclosure.

FIG. 3 illustrates a procedure for learning a machine learning model and uploading after receiving a data set according to an embodiment of the present disclosure.

FIG. 4 illustrates a procedure for determining whether a model structure is supportable according to an embodiment of the present disclosure.

FIG. 5 illustrates a procedure for receiving a data set and learning when a model structure is not supported according to an embodiment of the present disclosure.

FIG. 6 illustrates a procedure for acquiring a non-reference model according to the performance requirements of a reference model according to an embodiment of the present disclosure.

FIG. 7 illustrates a procedure for acquiring a model or data set according to a joint learning method according to an embodiment of the present disclosure.

FIG. 8 illustrates a procedure for acquiring a reference model according to joint learning methods 3 or 5 according to an embodiment of the present disclosure.

FIG. 9 illustrates a procedure for acquiring a non-reference model according to the performance requirements of a reference model according to an embodiment of the present disclosure.

FIG. 10 illustrates a procedure for acquiring a non-reference model according to joint learning method 4 according to an embodiment of the present disclosure.

FIG. 11 illustrates a procedure for integrated inference based on a reference model according to an embodiment of the present disclosure.

FIG. 12 illustrates a procedure for learning a device-specific AI model at a UE according to an embodiment of the present disclosure.

FIG. 13 illustrates a procedure for learning a device-specific AI model using a UE-side learning server according to an embodiment of the present disclosure.

FIG. 14 illustrates a procedure for learning a device-specific AI model based on a data set at a UE according to an embodiment of the present disclosure.

FIG. 15 illustrates a method of operation for a network according to an embodiment of the present disclosure.

FIG. 16 illustrates a method of operation for a UE according to an embodiment of the present disclosure.

FIG. 17 illustrates a configuration of a network in a wireless communication system according to various embodiments of the present disclosure.

FIG. 18 illustrates a configuration of a UE in a wireless communication system according to various embodiments of the present disclosure.

### DETAILED DESCRIPTION OF THE EMBODIMENTS

Terms used in this disclosure are used to describe specific embodiments and are not intended to limit the scope of other embodiments. The singular expressions include plural expressions unless the context clearly dictates otherwise. Technical or scientific terms, including terms used herein, may have the same meanings as commonly understood by one of ordinary skill in the art to which this disclosure belongs. Terms defined in general dictionaries may be interpreted as having meanings that are the same as or similar to their meanings in the context of the relevant art and are not to be interpreted in an idealized or overly formal sense unless expressly defined in this disclosure. In some cases, even terms defined in this disclosure may not be interpreted to exclude embodiments of the present disclosure.

In the various embodiments of the present disclosure described below, a hardware approach is exemplified. However, since the various embodiments of the present disclosure include technology that uses both hardware and software, the various embodiments of the present disclosure do not exclude software-based approaches.

In addition, in the detailed description and claims of this disclosure, “at least one of A, B, and C” may mean “only A,” “only B,” “only C,” or “any combination of A, B, and C.” Also, “at least one of A, B, or C” or “at least one of A, B, and/or C” may mean “at least one of A, B, and C.”

The present disclosure relates to an apparatus and method for integrated inference using dual-sided machine learning in wireless communication systems. Specifically, the present disclosure describes techniques for the learning, delivery, and efficient interoperation of models between UEs and networks for the alignment of dual-sided machine learning models in wireless communication systems.

More specifically, the present disclosure not only provides machine learning models trained to match the characteristics of UEs or network devices, but also relates to methods for receiving reference machine learning models or data sets and learning and operating machine learning models optimized for each device.

In the following description, terms referring to signals, terms referring to channels, terms referring to control information, terms referring to network entities, and terms referring to components of devices are exemplified for convenience of explanation. Therefore, the present disclosure is not limited to the terms described below, and other terms with equivalent technical meanings may be used.

Also, this disclosure describes various embodiments using terms used in some communication standards (e.g., 3rd Generation Partnership Project (3GPP)), but this is merely an example for explanation. The various embodiments of this disclosure can be readily modified and applied to other communication systems.

### [Method of Using Model and Data Set Storage Server for Dual-Sided Machine Learning Model Alignment]

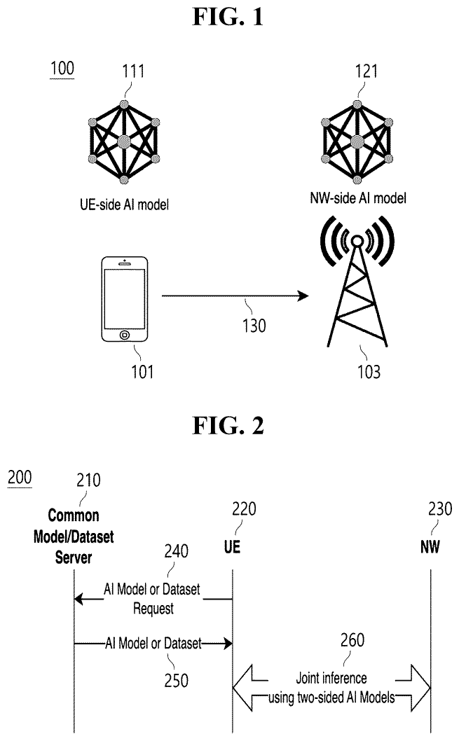

FIG. 1 illustrates a dual-sided machine learning model structure in a wireless communication system according to an embodiment of the present disclosure. Referring to FIG. 1, the overall structure for integrated inference using dual-sided machine learning models in a wireless communication system (100) is illustrated. A UE (110) includes a UE-side machine learning model (111), and a network (120) includes a network-side machine learning model (121). The UE-side machine learning model (111) and the network-side machine learning model (121) have constraints to operate together, and to satisfy this, they can be integrated in a mutually compatible form.

Integrated learning can be performed through centralized learning, distributed learning, or sequential learning. UE (110) and network (120) can pre-install machine learning models trained to correspond to the other device, or receive and install them from a server, or from the UE or network itself. According to one embodiment, the joint learning method can be implemented as standardized reference model information, standardized data set information, standardized reference model structure, standardized data set format, or standardized model format. According to one embodiment, the server may include a UE manufacturer server, a network manufacturer server, or a common server.

Channel state information (CSI) feedback between UE (110) and network (120) is performed integrally by dual-sided machine learning models (111, 121), allowing high-accuracy acquisition of channel state information while minimizing the occupation of wireless transmission resources and overhead. Each machine learning model (111, 121) can be configured in an optimized form considering the processing capabilities and storage space of the respective device, and the alignment performance can be continuously verified and updated if necessary.

FIG. 2 illustrates a procedure for downloading an AI model or data set using a common server according to an embodiment of the present disclosure.

Referring to FIG. 2, a procedure (200) for downloading an AI model or data set using a common server (common model/data set server) is illustrated. The common model/data set server (210) can receive requests from a UE (220) or network (230) to store and share machine learning models or data sets. The UE (220) transmits an AI model or data set request message (240) to the server (210), and the server (210) responds by transmitting an AI model or data set transmission message (250) to the UE (220). The UE (220) and network (230) can perform integrated inference (260) using dual-sided machine learning models. Machine learning models stored on the server (210) can be registered only after passing verification for performance or stability, and can be stored with additional information including the required inference processing capability or storage space size. The UE (220) has information about its own inference processing capability and storage space size, and when requesting machine learning model information from the server (210), it can additionally transmit its inference processing capability and storage space size information to receive information only about machine learning models that it can execute.

Additionally, the UE (220) can transmit the identifier of a machine learning model or data set to receive a machine learning model corresponding to the network's (230) machine learning model. If only data sets exist on the server (210) and no machine learning models are available, the UE can receive the relevant data set and learn a machine learning model. In this case, it receives performance target information along with the data set, and can only upload the model or perform inference with it if the learning meets the received performance target.

Machine learning model learning can be performed by the UE (220) or network (230), or it can be performed by a UE-side learning server or a network-side learning server. In this case, the data set for learning can be delivered directly from the server (210) to each side's learning server.

According to one embodiment, the UE may also receive the machine learning model or data set, or their identifiers, from the network rather than from the common server.

According to one embodiment, the common server may be accessible to all UEs and/or base stations, or it may be operated by specific UE or base station manufacturers, accessible only to specific UEs or base stations.

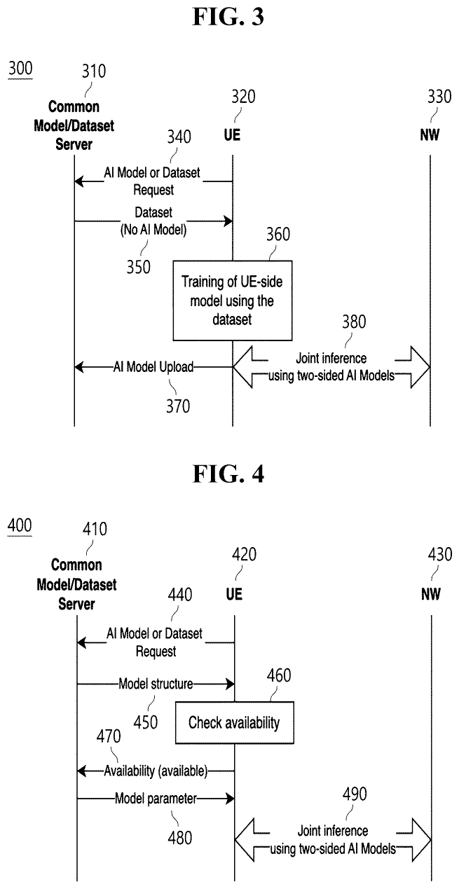

FIG. 3 illustrates a procedure for learning a machine learning model and uploading after receiving a data set according to an embodiment of the present disclosure.

Referring to FIG. 3, a procedure (300) for learning a machine learning model and uploading after receiving a data set is illustrated. The UE (320) can transmit an AI model or data set request message (340) to the common model/data set server (310). The UE (320) may first receive information about the model structure, and if inference is possible using the received model structure, it can request the model parameters again to receive and configure the complete model information.

If only data sets exist on the server (310) and no machine learning models are available, the server (310) can transmit the data set to the UE (320) through a data set transmission message (350). The UE (320) performs UE-side model learning (360) using the received data set. In this case, it receives performance target information along with the data set, and can only upload the learned model to the server (310) through an AI model upload message (370) if the learning satisfies the received performance target. Machine learning model learning can be performed directly by the UE (320) or by a UE-side learning server, in which case the data set for learning can be delivered directly from the server (310) to the UE-side learning server. The learned model can perform integrated inference (380) with the network's (330) machine learning model.

According to one embodiment, the UE may also receive the machine learning model or data set, or their identifiers, from the network rather than from the common server.

According to one embodiment, the common server may be accessible to all UEs and/or base stations, or it may be operated by specific UE or base station manufacturers, accessible only to specific UEs or base stations.

FIG. 4 illustrates a procedure for determining whether a model structure is supportable according to an embodiment of the present disclosure.

Referring to FIG. 4, a procedure (400) for determining whether a model structure is supportable is illustrated. The UE (420) can transmit an AI model or data set request message (440) to the common model/data set server (410). The server (410) can first transmit model structure information to the UE (420) through a model structure transmission message (450). The UE (420) determines whether inference is possible using the received model structure through an inference feasibility check process (460), and can transmit an availability response message (470) to the server (410).

If inference is possible, the UE (420) requests model parameters from the server (410), and the server (410) transmits the model parameters through a model parameter transmission message (480), and the UE (420) receives this to configure the complete model. The configured model can perform integrated inference (490) with the network's (430) machine learning model. If the UE (420) determines that inference is not possible using the received model structure, the UE (420) can additionally receive reference model information and data sets for non-reference model development to learn a machine learning model. In this case, it receives performance target information along with the data set, and can only perform operations using it if the learning satisfies the received performance target.

Additionally, the UE can receive the network-side (430) model to measure the performance of the dual-sided machine learning model, and can only upload the model or perform inference with it if the measured performance meets the target. Machine learning model learning can be performed directly by the UE (420) or by a UE-side learning server, in which case the data set for learning can be delivered directly from the server (410) to the UE-side learning server. After learning is completed, the machine learning model can also be registered directly at each manufacturer's learning server.

According to one embodiment, the UE may also receive the machine learning model or data set, or their identifiers, from the network rather than from the common server.

According to one embodiment, the common server may be accessible to all UEs and/or base stations, or it may be operated by specific UE or base station manufacturers, accessible only to specific UEs or base stations.

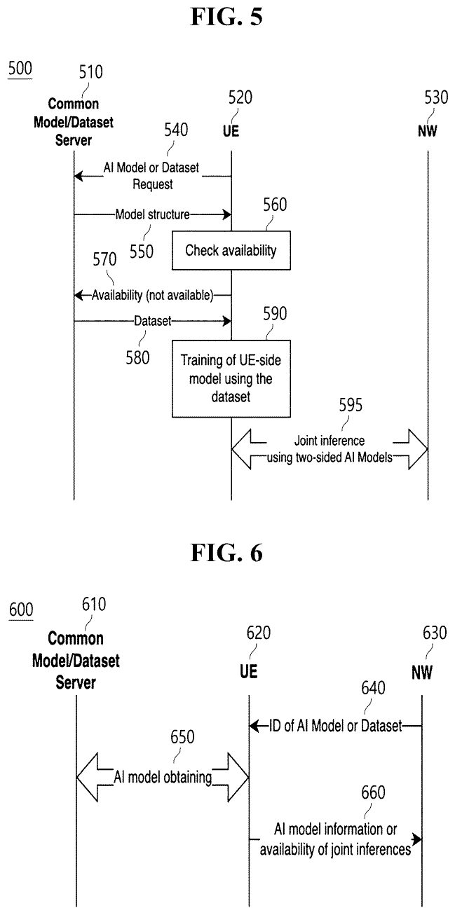

FIG. 5 illustrates a procedure for receiving a data set and learning when a model structure is not supported according to an embodiment of the present disclosure.

Referring to FIG. 5, a procedure (500) for receiving a data set and learning when a model structure is not supported is illustrated. The UE (520) can transmit an AI model or data set request message (540) to the common model/data set server (510). The server (510) can first transmit model structure information to the UE (520) through a model structure transmission message (550). The UE (520) determines whether inference is possible using the received model structure through an inference feasibility check process (560), and if inference is not possible, can transmit an availability response message (570) to the server (510). Subsequently, the server (510) can transmit a data set to the UE (520) through a data set transmission message (580). The UE (520) can learn a non-reference model using the received data set through a UE-side model learning process (590). In this case, it receives performance target information along with the data set, and can only perform operations using it if the learning satisfies the received performance target. The performance target information can be delivered in the form of Squared Generalized Cosine Similarity (SGCS) or Normalized Mean Squared Error (NMSE). Additionally, it can receive the network-side (530) model to measure the performance of the dual-sided machine learning model, and can only upload the model or perform inference with it if the measured performance meets the target. Machine learning model learning can be performed directly by the UE (520) or by a UE-side learning server, in which case the data set for learning can be delivered directly from the server (510) to the UE-side learning server. After learning is completed, integrated inference (595) using dual-sided machine learning models can be performed.

According to one embodiment, the UE may also receive the machine learning model or data set, or their identifiers, from the network rather than from the common server.

According to one embodiment, the common server may be accessible to all UEs and/or base stations, or it may be operated by specific UE or base station manufacturers, accessible only to specific UEs or base stations.

### [Method for UE to Acquire UE-Side Machine Learning Model]

FIG. 6 illustrates a procedure for acquiring a non-reference model according to the performance requirements of a reference model according to an embodiment of the present disclosure.

Referring to FIG. 6, a procedure (600) for acquiring a non-reference model according to the performance requirements of a reference model is illustrated. The network (630) can transmit an AI model or data set identifier transmission message (640) to the UE (620). The UE (620) can perform an AI model acquisition process (650) with the common model/data set server (610). In the AI model acquisition process (650), the UE (620) first receives information about the model structure, and if inference is possible using the received model structure, it requests model parameters to receive and configure the complete model information.

If inference is not possible, the UE (620) can additionally receive reference model information for non-reference model development. The reference model information can be a UE-side machine learning model and/or a network-side machine learning model. Additionally, it can receive performance target information for learning and only perform operations using it if it meets the target performance.

The network (630) can check the model configuration status of the UE (620) through an AI model information or integrated inference availability message (660). According to one embodiment, the UE (620) can receive the identifier of the machine learning model included in the network (630) and information about the joint learning method from the network (630), and can request machine learning model information from the server (610) based on the joint learning method, including the UE's processing capability and storage space information.

According to one embodiment, the UE may also receive machine learning model information from the network rather than from the common server.

According to one embodiment, the common server may be accessible to all UEs and/or base stations, or it may be operated by specific UE or base station manufacturers, accessible only to specific UEs or base stations.

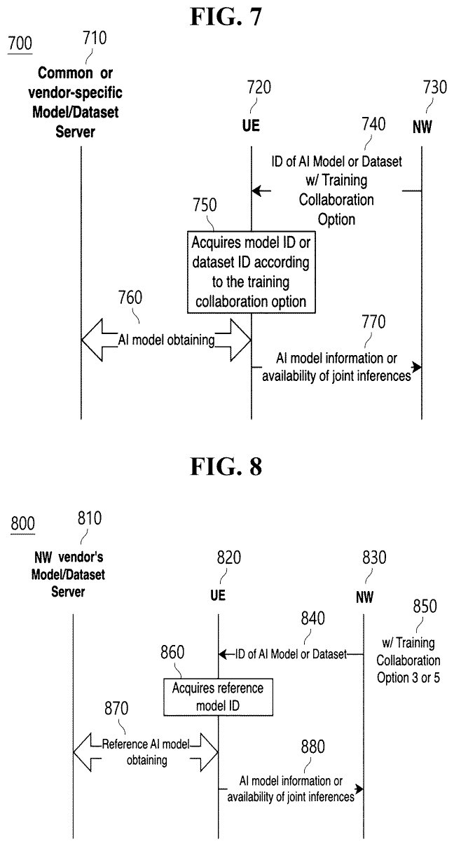

FIG. 7 illustrates a procedure for acquiring a model or data set according to a joint learning method according to an embodiment of the present disclosure.

Referring to FIG. 7, a procedure (700) for acquiring a model or data set according to a joint learning method is illustrated. The network (730) can transmit an AI model or data set identifier transmission message (740) that includes joint learning options to the UE (720). According to one embodiment, the joint learning method can be one of the following options:
(1) Option 1: Standardized reference model information (structure and parameters)
(2) Option 2: Standardized data set information
(3) Option 3: Standardized reference model structure (parameter exchange needed)
(4) Option 4: Standardized data set format, or
(5) Option 5: Standardized model format (reference model structure and parameter exchange needed)

For Options 1 and 2, it can be assumed that corresponding models are pre-installed.

For Options 3 through 5, it can be assumed that corresponding models may not be pre-installed.

For Options 3 and 5, a UE-side reference model identifier may be expected to be received additionally.

For Option 4, a UE-side data set identifier may be expected to be received additionally.

The UE (720) can perform a model/data set identifier acquisition process (750) according to the joint learning option.

The UE (720) can perform an AI model acquisition process (760) with the common or manufacturer-specific model/data set server (710) to acquire a model or data set suitable for the corresponding joint learning method. According to one embodiment, the UE (720) can check whether the performance and stability of the model have been verified before receiving the machine learning model from the server (710). If the joint learning method is a standardized reference model structure or a standardized model format, the UE (720) can additionally receive information about the required inference processing capability and storage space size of the reference machine learning model from the network (730). The network (730) can check the model configuration status of the UE (720) through an AI model information or integrated inference availability message (770).

According to one embodiment, the UE may also receive machine learning model information from the network rather than from the common server.

According to one embodiment, the server may be accessible to all UEs and/or base stations, or it may be operated by specific UE or base station manufacturers, accessible only to specific UEs or base stations.

FIG. 8 illustrates a procedure for acquiring a reference model according to joint learning methods 3 or 5 according to an embodiment of the present disclosure.

Referring to FIG. 8, a procedure (800) for acquiring a reference model according to joint learning methods 3 or 5 is illustrated. The network (830) can transmit an AI model or data set identifier transmission message (840) to the UE (820). According to one embodiment, the data set identifier can be information that specifies the data set needed for the UE to acquire a model corresponding to the network's machine learning model.

The AI model or data set identifier transmission message (840) can include Option 3 (standardized reference model structure) or Option 5 (standardized model format) (850) among joint learning options.

The UE (820) performs a reference model identifier acquisition process (860) and a reference AI model acquisition process (870) with the network manufacturer's model/data set server (810). In the operation process (870), the UE (820) can receive information about the required inference processing capability and storage space size of the reference machine learning model. If the UE (820) cannot perform inference using the reference machine learning model due to insufficient inference processing capability or storage space size, the UE (820) can request the learning of a non-reference model based on the reference machine learning model from the UE-side learning server. In this case, the inference processing capability and storage space size information of the UE can be additionally transmitted to the UE-side learning server. The non-reference model learned at the UE-side learning server includes the identifier of the original reference model or the identifier of the data set used for learning as additional information, allowing the relationship between models to be confirmed later.

The network (830) can check the model configuration status of the UE (820) through an AI model information or integrated inference availability message (880).

According to one embodiment, the UE may also receive reference machine learning model information from the network instead of from the network manufacturer's model/data set server (810).

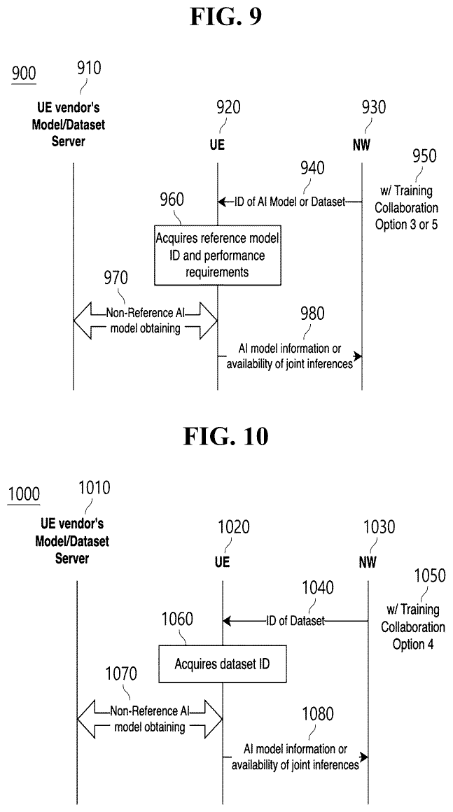

FIG. 9 illustrates a procedure for acquiring a non-reference model according to the performance requirements of a reference model according to an embodiment of the present disclosure.

Referring to FIG. 9, a procedure (900) for acquiring a non-reference model according to the performance requirements of a reference model is illustrated. The network (930) can transmit an AI model or data set identifier transmission message (940) to the UE (920). The AI model or data set identifier transmission message (940) can include Option 3 (standardized reference model structure) or Option 5 (standardized model format) (950) among joint learning options. According to one embodiment, the joint learning method can consist of five options: standardized reference model information, standardized data set information, standardized reference model structure, standardized data set format, or standardized model format. The UE (920) performs a reference model identifier and performance requirements acquisition process (960) and a non-reference AI model acquisition process (970) with the UE manufacturer's model/data set server (910). In process (970), the UE (920) receives information about the required inference processing capability and storage space size of the reference machine learning model, and if the UE's inference processing capability or storage space size is insufficient, it can acquire a non-reference model. In this case, the UE (920) can request the learning of a non-reference model based on the reference machine learning model from the UE-side learning server, and can additionally transmit the UE's inference processing capability and storage space size information to the UE-side learning server. The network (930) can check the model configuration status of the UE (920) through an AI model information or integrated inference availability message (980).

FIG. 10 illustrates a procedure for acquiring a non-reference model according to joint learning method 4 according to an embodiment of the present disclosure.

Referring to FIG. 10, a procedure (1000) for acquiring a non-reference model according to joint learning method 4 is illustrated. The network (1030) can transmit a data set identifier transmission message (1040) to the UE (1020). According to one embodiment, the data set identifier can be information that specifies the data set needed for the UE to learn a model corresponding to the network's machine learning model.

The data set identifier transmission message (1040) can include joint learning Option 4 (standardized data set format) (1050). The UE (1020) performs a data set identifier acquisition process (1060) and a non-reference AI model acquisition process (1070) with the UE manufacturer's model/data set server (1010). The UE (1020) can additionally transmit the data set identifier of the machine learning model included in the network (1030) to the UE-side learning server or common server, thereby maintaining the relationship between the learned model and the original data set.

The UE (1020) can additionally transmit the UE's inference processing capability and storage space size information to the UE-side learning server.

The network (1030) can check the model configuration status of the UE (1020) through an AI model information or integrated inference availability message (1080).

### [UE's UE-Side Machine Learning Model Learning or Direct Inference Procedure]

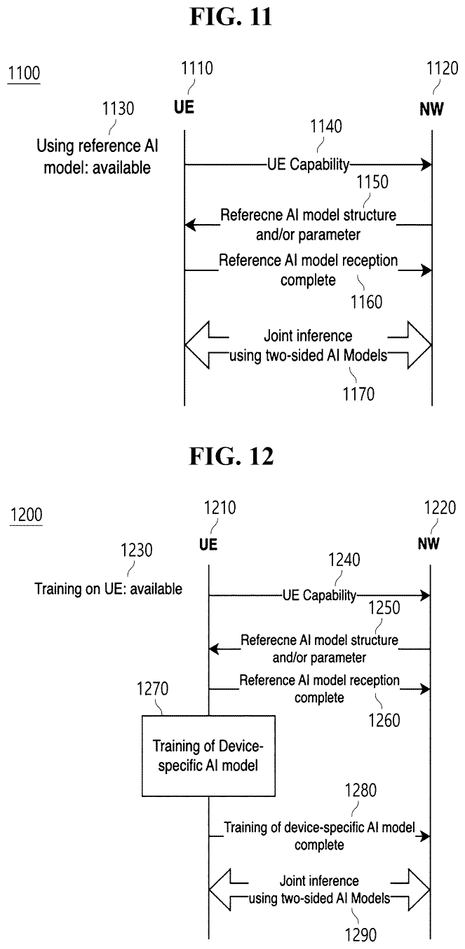

FIG. 11 illustrates a procedure for integrated inference based on a reference model according to an embodiment of the present disclosure.

Referring to FIG. 11, a procedure (1100) for integrated inference based on a reference model is illustrated.

The UE (1110) can indicate whether inference using a reference machine learning model is possible at the UE through a reference AI model usability status message (1130).

The UE (1110) can transmit the UE's capability information to the network (1120) through a UE capability information transmission message (1140). According to one embodiment, the UE's capability information may include one or more of: whether inference using a reference machine learning model is possible, whether learning is possible, whether a UE-side learning server is used, and information about the UE-side learning server, and may include details such as model size or data set size.

The network (1120) can transmit the structure and/or parameters of the reference model to the UE (1110) through a reference AI model structure/parameter transmission message (1150) based on the received UE capability information. The transmission method can be divided into two types.

The first method can be to directly transmit the entire model structure and/or parameter information. For example, the entire model structure and/or parameter information can be directly transmitted through higher layer signaling such as an RRC reconfiguration message.

The second method can be to indirectly transmit the entire model structure and/or parameter information. For example, indicators such as URL information can be transmitted through higher layer signaling, and the UE can indirectly acquire the information through this.

When the UE (1110) has received all UE-side reference machine learning information directly or indirectly, it can notify the network (1120) through a reference AI model reception completion message (1160). According to one embodiment, the reference AI model reception completion message can be transmitted through higher layer signaling.

If the network (1120) does not receive the reception completion message within a certain time, it can perform retransmission, and if repeated retransmissions fail, it can determine that the UE-side reference machine learning delivery procedure has failed.

Finally, the UE (1110) and network (1120) can perform integrated inference (1170) using dual-sided machine learning models. According to one embodiment, integrated inference can be performed in a manner where the machine learning models on the UE-side and network-side operate in conjunction with each other.

FIG. 12 illustrates a procedure for learning a device-specific AI model at a UE according to an embodiment of the present disclosure.

Referring to FIG. 12, a procedure (1200) for learning a device-specific AI model at a UE is illustrated.

The UE (1210) can indicate whether learning is possible at the UE through a UE learning capability status message (1230). The UE (1210) can transmit the UE's capability information to the network (1220) through a UE capability information transmission message (1240). According to one embodiment, the UE's capability information may include one or more of: whether inference using a reference machine learning model is possible, whether learning is possible, whether a UE-side learning server is used, and information about the UE-side learning server, and may include details such as model size or data set size.

The network (1220) can transmit the structure and/or parameters of the reference model to the UE (1210) through a reference AI model structure/parameter transmission message (1250) based on the received UE capability information and determining that learning is possible at the UE.

The transmission method can be divided into two types.

The first method can be to directly transmit the entire model structure and/or parameter information through higher layer signaling such as an RRC reconfiguration message.

The second method can be to transmit indicators such as URL information through higher layer signaling, and the UE can indirectly acquire the information through this.

When the UE (1210) has received all UE-side reference machine learning information directly or indirectly, it can notify the network (1220) through a reference AI model reception completion message (1260). According to one embodiment, the reference AI model reception completion message can be transmitted through higher layer signaling.

If the network (1220) does not receive the reception completion message within a certain time, it can perform retransmission, and if repeated retransmissions fail, it can determine that the UE-side reference machine learning delivery procedure has failed.

The UE (1210) performs a device-specific AI model learning process (1270), and when learning is completed, transmits a device-specific AI model learning completion message (1280) to the network (1220).

Finally, the UE (1210) and network (1220) can perform integrated inference (1290) using dual-sided machine learning models. According to one embodiment, integrated inference can be performed in a manner where the machine learning models on the UE-side and network-side operate in conjunction with each other.

According to one embodiment, the device-specific AI model learning process (1270) can be performed at the UE or can be learned using a separate UE-side learning server. In this case, the received reference machine learning model information and additional information can be transmitted to the UE-side learning server to perform learning.

Additionally, this disclosure discloses that the UE may receive the structure and/or parameters of the UE-side reference machine learning model, or the structure and/or parameters of the base station-side machine learning model, or the structure and/or parameters of both the UE-side reference machine learning model and the base station-side machine learning model. For this purpose, the UE can include learning-related information for dual-sided machine learning models as UE capability information, and the UE capability information can include one or more of the following information needed for training a UE-side non-reference machine learning model:
(1) Whether the structure and/or parameters of the UE-side reference machine learning model are needed
(2) Whether the structure and/or parameters of the base station-side machine learning model are needed

The aforementioned structure and/or parameters of the UE-side reference machine learning model, or the structure and/or parameters of the base station-side machine learning model, or the structure and/or parameters of both the UE-side reference machine learning model and the base station-side machine learning model can be transmitted from the UE, or from the base station to the UE-side learning server.

Furthermore, the UE can additionally receive additional learning data sets for learning, additional validation data sets for validation, and/or target performance information for validation. For this purpose, the UE can include one or more of the following information as learning-related information for dual-sided machine learning models:
(1) Whether additional learning data sets are needed
(2) Whether additional validation data sets are needed
(3) Whether target performance information for validation is needed

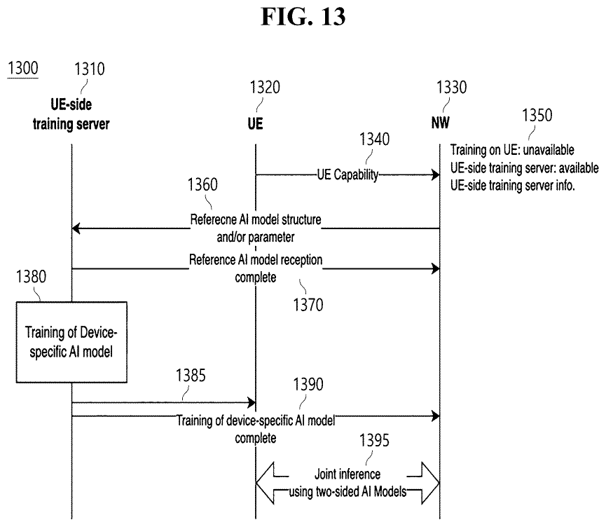

FIG. 13 illustrates a procedure for learning a device-specific AI model using a UE-side learning server according to an embodiment of the present disclosure.

Referring to FIG. 13, a procedure (1300) for learning a device-specific AI model using a UE-side learning server is illustrated.

The UE (1320) can transmit the UE's capability information to the network (1330) through a UE capability information transmission message (1340). According to one embodiment, the UE's capability information may include whether inference using a reference machine learning model is possible, whether learning is not possible at the UE, whether a UE-side learning server (1310) is used and server information, and may include details such as model size or data set size.

The network (1330) can check the UE's learning inability status and the availability of a UE-side learning server through a UE learning inability and server information message (1350).

Subsequently, the network (1330) can transmit the structure and/or parameters of the reference model to the UE-side learning server (1310) through a reference AI model structure/parameter transmission message (1360). The transmission method can be divided into two types.

The first method is to directly transmit the entire model structure and/or parameter information.

The second method is to transmit indicators such as URL information, and the UE-side learning server acquires the information indirectly through this.

After receiving all information directly or indirectly, the UE-side learning server (1310) can transmit a reference AI model reception completion message (1370) to the network (1330).

If the network (1330) does not receive the reception completion message within a certain time, it can perform retransmission, and if repeated retransmissions fail, it can determine that the delivery procedure has failed.

The UE-side learning server (1310) performs a device-specific AI model learning process (1380) and checks the learning results (1385). When learning is completed, it can transmit a device-specific AI model learning completion message (1390) to the network (1330) through the UE (1320).

The network (1330) can transmit a completion message for the delivery of UE-side machine learning model and parameter information to the UE (1320).

Finally, the UE (1320) and network (1330) can perform integrated inference (1395) using dual-sided machine learning models. According to one embodiment, integrated inference can be performed in a manner where the machine learning models on the UE-side and network-side operate in conjunction with each other.

Additionally, this disclosure discloses that the UE-side learning server (1310) may receive the structure and/or parameters of the UE-side reference machine learning model, or the structure and/or parameters of the base station-side machine learning model, or the structure and/or parameters of both the UE-side reference machine learning model and the base station-side machine learning model. For this purpose, the UE can include learning-related information for dual-sided machine learning models as UE capability information, and the UE capability information can include one or more of the following information needed for training a UE-side non-reference machine learning model:
(1) Whether the structure and/or parameters of the UE-side reference machine learning model are needed
(2) Whether the structure and/or parameters of the base station-side machine learning model are needed

The aforementioned structure and/or parameters of the UE-side reference machine learning model, or the structure and/or parameters of the base station-side machine learning model, or the structure and/or parameters of both the UE-side reference machine learning model and the base station-side machine learning model can be transmitted from the UE, or from the base station to the UE-side learning server.

Furthermore, the UE-side learning server (1310) can additionally receive additional learning data sets for learning, additional validation data sets for validation, and/or target performance information for validation. For this purpose, the UE can include one or more of the following information as learning-related information for dual-sided machine learning models:
(1) Whether additional learning data sets are needed
(2) Whether additional validation data sets are needed
(3) Whether target performance information for validation is needed

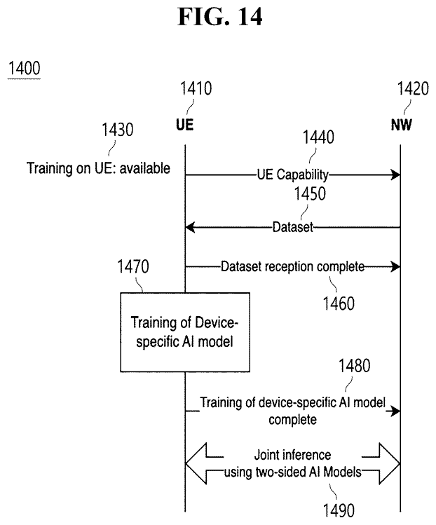

FIG. 14 illustrates a procedure for learning a device-specific AI model based on a data set at a UE according to an embodiment of the present disclosure.

Referring to FIG. 14, a procedure (1400) for learning a device-specific AI model based on a data set at a UE is illustrated.

The UE (1410) indicates whether learning is possible at the UE through a UE learning capability status message (1430).

The UE (1410) can transmit the UE's capability information to the network (1420) through a UE capability information transmission message (1440). According to one embodiment, the UE's capability information may include information about learning capability and processable data set size.

The network (1420) can transmit a data set for learning to the UE (1410) through a data set transmission message (1450) based on the received UE capability information. According to one embodiment, data set transmission can be done through higher layer signaling.

When the UE (1410) has received the entire data set, it can notify the network (1420) through a data set reception completion message (1460). If the network (1420) does not receive the reception completion message within a certain time, it can perform retransmission. The UE (1410) performs a device-specific AI model learning process (1470), and when learning is completed, transmits a device-specific AI model learning completion message (1480) to the network (1420).

Finally, the UE (1410) and network (1420) can perform integrated inference (1490) using dual-sided machine learning models. According to one embodiment, integrated inference can be performed in a manner where the machine learning models on the UE-side and network-side operate in conjunction with each other.

According to one embodiment, the device-specific AI model learning process (1470) can be performed at the UE or can be learned using a separate UE-side learning server. In this case, the received data set information and additional information can be transmitted to the UE-side learning server to perform learning.

Also, as in FIG. 13, the data set information and additional information can be directly transmitted from the network to the UE-side learning server to perform learning.

Additionally, this disclosure discloses that the UE may receive the structure and/or parameters of the UE-side reference machine learning model, or the structure and/or parameters of the base station-side machine learning model, or the structure and/or parameters of both the UE-side reference machine learning model and the base station-side machine learning model. For this purpose, the UE can include learning-related information for dual-sided machine learning models as UE capability information, and the UE capability information can include one or more of the following information needed for training a UE-side non-reference machine learning model:
(1) Whether the structure and/or parameters of the UE-side reference machine learning model are needed
(2) Whether the structure and/or parameters of the base station-side machine learning model are needed

The aforementioned structure and/or parameters of the UE-side reference machine learning model, or the structure and/or parameters of the base station-side machine learning model, or the structure and/or parameters of both the UE-side reference machine learning model and the base station-side machine learning model can be transmitted from the UE, or from the base station to the UE-side learning server.

Furthermore, the UE can additionally receive additional learning data sets for learning, additional validation data sets for validation, and/or target performance information for validation. For this purpose, the UE can include one or more of the following information as learning-related information for dual-sided machine learning models:
(1) Whether additional learning data sets are needed
(2) Whether additional validation data sets are needed
(3) Whether target performance information for validation is needed

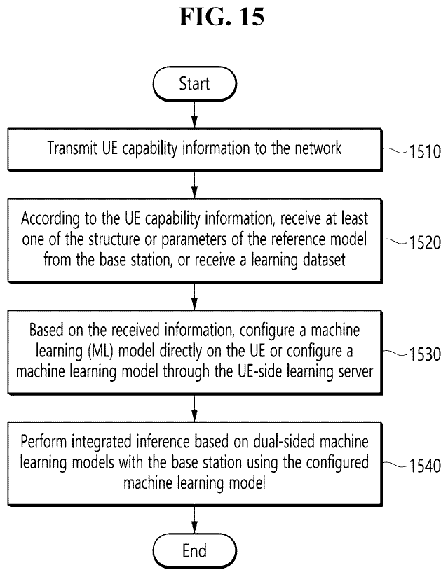

FIG. 15 illustrates a method of operation for a UE according to an embodiment of the present disclosure.

Referring to FIG. 15, a procedure for a UE's dual-sided machine learning model-based integrated inference is illustrated.

First, the UE transmits the UE's capability information to the network (1510). According to one embodiment, the UE can first indicate whether inference using a reference machine learning model is possible at the UE through a reference AI model usability status message. The

UE's capability information may include one or more of: whether inference using a reference machine learning model is possible, whether learning is possible, whether a UE-side learning server is used, or data set processing capability information, and may also include details such as model size or data set size.

Next, the UE receives at least one of the structure or parameters of a reference model, or receives a learning data set from the network according to the UE's capability information (1520). According to one embodiment, the transmission method can be divided into two types. The first method is to directly receive the entire model structure and/or parameter information through higher layer signaling such as a Radio Resource Control (RRC) reconfiguration message. The second method is to receive indicators such as Uniform Resource Locator (URL) information through higher layer signaling, and the UE indirectly acquires the information through this.

When the UE has received all UE-side reference machine learning information directly or indirectly, it notifies the network through a reference AI model reception completion message.

The reference AI model reception completion message can be transmitted through higher layer signaling. If the network does not receive the reception completion message within a certain time, it can perform retransmission, and if repeated retransmissions fail, it can determine that the UE-side reference machine learning delivery procedure has failed.

Then, based on the received information, the UE directly configures a machine learning (ML) model on the UE or configures a machine learning model through a UE-side learning server (1530). When the UE performs learning directly, it can first indicate whether learning is possible at the UE through a UE learning capability status message. When configuring a machine learning model through a UE-side learning server, the UE can transmit its inference processing capability and storage space size information to the UE-side learning server. The UE also transmits information about its learning inability and the use of a UE-side learning server, along with server information, to the network, allowing the network to check the UE's learning inability status and the availability of a UE-side learning server. During the learning process, the learning results can be checked, and when learning is completed, a device-specific AI model learning completion message is transmitted to the network. A message about the completion of UE-side machine learning model and parameter information delivery may also be received from the network.

Finally, the UE performs integrated inference based on dual-sided machine learning models with the network using the configured machine learning model (1540). Integrated inference is performed in a manner where the machine learning models on the UE-side and network-side operate in conjunction with each other, enabling efficient Channel State Information (CSI) feedback.

Through this procedure, the UE can configure a machine learning model in the most appropriate way according to its capabilities and situation, and perform efficient integrated inference with the network.

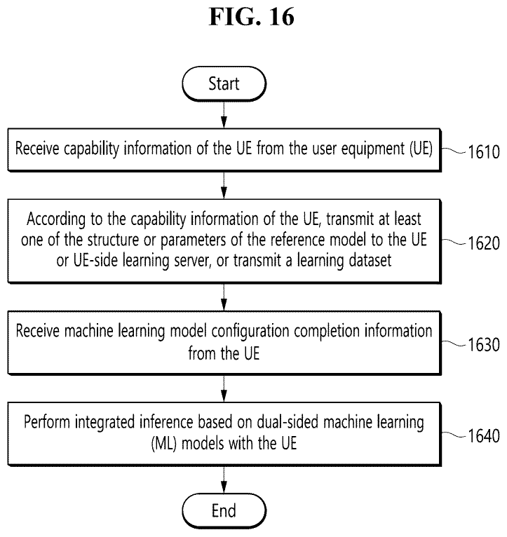

FIG. 16 illustrates a method of operation for a network according to an embodiment of the present disclosure.

Referring to FIG. 16, a procedure for a network's dual-sided machine learning model-based integrated inference is illustrated. The network first receives UE capability information from a user equipment (UE) (1610). According to one embodiment, the UE's capability information may include one or more of: whether inference using a reference machine learning model is possible, whether learning is possible, whether a UE-side learning server is used, or data set processing capability information, and may also include details such as model size or data set size.

The network can first receive a reference AI model usability status message from the UE to check whether inference using a reference machine learning model is possible at the UE. It can also check whether learning is possible at the UE through a UE learning capability status message from the UE. If the UE is incapable of learning, it receives information about the use of a UE-side learning server and server information together to check the UE's learning inability status and the availability of a UE-side learning server. The network also receives information about the UE's processing capability and storage space to determine an appropriate transmission method based on this. If the UE can perform data set-based learning, it also receives information about the UE's processable data set size. The network can comprehensively analyze this UE capability information to determine the most suitable model configuration method.

Next, according to the analyzed UE capability information, the network transmits at least one of the structure or parameters of a reference model, or transmits a learning data set to the UE or a UE-side learning server (1620). According to one embodiment, the transmission method can be broadly divided into four cases. First, if the UE can directly use a reference model, the entire model structure and/or parameter information can be directly transmitted through higher layer signaling such as a Radio Resource Control (RRC) reconfiguration message. Second, indicators such as Uniform Resource Locator (URL) information can be transmitted so that the UE can indirectly acquire the information. Third, if the UE is capable of direct learning, a learning data set can be transmitted. Fourth, if a UE-side learning server is used, reference model information or data sets can be directly transmitted to the UE-side learning server. According to one embodiment, when transmitting the structure and parameters of a reference model, information about the required inference processing capability and storage space size can also be transmitted to allow the UE or learning server to determine whether appropriate processing is possible by comparing with their capabilities.

Then, the network receives machine learning model configuration completion information from the UE (1630). Reception completion messages for the transmitted information are received through higher layer signaling, and if a reception completion message is not received within a certain time, retransmission can be performed. Retransmission is attempted a set number of times, and if all repeated retransmissions fail, the delivery procedure is determined to have failed and another transmission method can be attempted. If a machine learning model is configured through a UE-side learning server, learning results can be periodically received from the UE-side learning server to monitor the learning progress. When learning is completed, a device-specific AI model learning completion message is received from the UE, and in response, a completion message for the delivery of machine learning model and parameter information can be transmitted to the UE. According to one embodiment, the network can confirm that each step of the model configuration process is successfully completed through message exchanges.

Finally, the network performs integrated inference based on dual-sided machine learning (ML) models with the UE (1640). Integrated inference is performed in a manner where the machine learning models on the UE-side and network-side operate in conjunction with each other. This enables efficient Channel State Information (CSI) feedback, allowing high-accuracy acquisition of channel state information while minimizing the occupation of wireless transmission resources and overhead. All message exchanges during the integrated inference process are done through higher layer signaling, with successful execution at each step being confirmed and, if necessary, retransmission or error recovery procedures being performed.

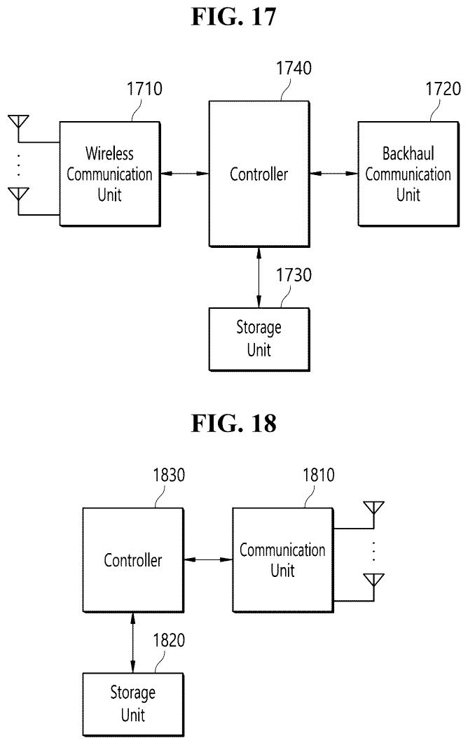

Through this detailed procedure, the network can deliver machine learning model information in the most appropriate way according to the UE's various capabilities and situations, and perform stable and efficient integrated inference. In particular, optimized model configuration considering the UE's processing capability and storage space is possible, and reliable model configuration and integrated inference can be guaranteed through various transmission methods and error recovery mechanisms. FIG. 17 illustrates a configuration of a network in a wireless communication system according to various embodiments of the present disclosure. The configuration illustrated in FIG. 17 can be understood as a configuration of a network. The terms “ . . . unit”, “ . . . device”, etc. used below refer to units that process at least one function or operation, and these can be implemented with hardware or software, or a combination of hardware and software. Referring to FIG. 17, the network includes a wireless communication unit (1710), a backhaul communication unit (1720), a storage unit (1730), and a controller (1740). The wireless communication unit (1710) can transmit and receive wireless signals through wireless channels. For example, the wireless communication unit (1710) can perform conversion functions between baseband signals and bit sequences according to the physical layer specifications of the system. Also, when transmitting data, the wireless communication unit (1710) can generate complex symbols by encoding and modulating transmission bit sequences. When receiving data, the wireless communication unit (1710) can restore reception bit sequences through demodulation and decoding of baseband signals.

The wireless communication unit (1710) can up-convert baseband signals to RF (radio frequency) band signals and transmit them through antennas, and down-convert RF band signals received through antennas to baseband signals. For this purpose, the wireless communication unit (1710) may include transmission filters, reception filters, amplifiers, mixers, oscillators, DACs (digital to analog converters), and ADCs (analog to digital converters).

The wireless communication unit (1710) may include multiple transmission and reception paths, and the wireless communication unit (1710) may include at least one antenna array composed of multiple antenna elements.

From a hardware perspective, the wireless communication unit (1710) may include a digital unit and an analog unit, and the analog unit may include multiple sub-units depending on operating power, operating frequency, etc. The digital unit can be implemented with at least one processor (e.g., a digital signal processor (DSP)).

The wireless communication unit (1710) can transmit and receive wireless signals as described above. Accordingly, all or part of the wireless communication unit (1710) may be referred to as a “transmitter”, “receiver”, or “transceiver”. Also, in the following description, transmission and reception performed through wireless channels may include processing performed by the wireless communication unit (1710) as described above.

The backhaul communication unit (1720) can provide an interface for communicating with other nodes in the network. That is, the backhaul communication unit (1720) can convert bit sequences to be transmitted from the network to other nodes, such as other access nodes, other networks, higher nodes, and core networks, into physical signals, and convert physical signals received from other nodes into bit sequences.

The storage unit (1730) can store basic programs, application programs, setting information, and other data for the operation of the network. The storage unit (1730) can be composed of volatile memory, non-volatile memory, or a combination of volatile and non-volatile memory. And, the storage unit (1730) can provide stored data according to requests from the controller (1740).

The controller (1740) can control the overall operations of the network. For example, the controller (1740) can transmit and receive signals through the wireless communication unit (1710) or the backhaul communication unit (1720). Also, the controller (1740) can write and read data to and from the storage unit (1730). Additionally, the controller (1740) can perform functions of the protocol stack required by communication standards.

For this purpose, the controller (1740) may include at least one processor.

According to various embodiments of the present disclosure, the controller (1740) can control the network to perform various operations according to the various embodiments described above.

FIG. 18 illustrates a configuration of a UE in a wireless communication system according to various embodiments of the present disclosure. The configuration illustrated in FIG. 18 can be understood as a configuration of a UE. The terms “ . . . unit”, “ . . . device”, etc. used below refer to units that process at least one function or operation, and these can be implemented with hardware or software, or a combination of hardware and software.

Referring to FIG. 18, the UE includes a communication unit (1810), a storage unit (1820), and a controller (1830).

The communication unit (1810) can perform functions for transmitting and receiving signals through wireless channels. For example, the communication unit (1810) can perform conversion functions between baseband signals and bit sequences according to the physical layer specifications of the system. For example, when transmitting data, the communication unit (1810) can generate complex symbols by encoding and modulating transmission bit sequences. When receiving data, the communication unit (1810) can restore reception bit sequences through demodulation and decoding of baseband signals. Also, the communication unit (1810) can up-convert baseband signals to RF band signals and transmit them through antennas, and down-convert RF band signals received through antennas to baseband signals. For example, the communication unit (1810) may include transmission filters, reception filters, amplifiers, mixers, oscillators, DACs, ADCs, etc.

Additionally, the communication unit (1810) may include multiple transmission and reception paths. Furthermore, the communication unit (1810) may include at least one antenna array composed of multiple antenna elements. From a hardware perspective, the communication unit (1810) can be composed of digital circuits and analog circuits (e.g., a radio frequency integrated circuit (RFIC)). Here, the digital circuits and analog circuits can be implemented as a single package. Also, the communication unit (1810) may include multiple RF chains. Furthermore, the communication unit (1810) can perform beamforming.

The communication unit (1810) transmits and receives signals as described above. Accordingly, all or part of the communication unit (1810) may be referred to as a “transmitter”, “receiver”, or “transceiver”. Also, in the following description, transmission and reception through wireless channels may include processing performed by the communication unit (1810) as described above.

The storage unit (1820) can store basic programs, application programs, setting information, and other data for the operation of the UE. The storage unit (1820) can be composed of volatile memory, non-volatile memory, or a combination of volatile and non-volatile memory. And, the storage unit (1820) can provide stored data according to requests from the controller (1830).

The controller (1830) can control the overall operations of the UE. For example, the controller (1830) can transmit and receive signals through the communication unit (1810). Also, the controller (1830) can write and read data to and from the storage unit (1820). The controller (1830) can perform functions of the protocol stack required by communication standards. For this purpose, the controller (1830) may include at least one processor or micro-processor, or may be part of a processor. Additionally, part of the communication unit (1810) and the controller (1830) may be referred to as a communication processor (CP).

According to various embodiments, the controller (1830) can control the UE to perform various operations according to the various embodiments described above.

Methods according to embodiments described in the claims or specification of the present disclosure can be implemented in the form of hardware, software, or a combination of hardware and software.

When implemented in software, one or more programs (software modules) can be provided in a computer-readable storage medium. One or more programs stored in the computer-readable storage medium are configured for execution by one or more processors within an electronic device. One or more programs include instructions that cause the electronic device to execute the methods according to the embodiments described in the claims or specification of the present disclosure.

These programs (software modules, software) can be stored in random access memory, non-volatile memory including flash memory, read-only memory (ROM), electrically erasable programmable read-only memory (EEPROM), magnetic disk storage devices, compact disc-ROM (CD-ROM), digital versatile discs (DVDs) or other forms of optical storage devices, magnetic cassettes. Or, they can be stored in memory composed of a combination of some or all of these. Also, each constituent memory may include multiple instances.

Additionally, programs can be stored in attachable storage devices that can be accessed through communication networks such as the Internet, Intranet, local area network (LAN), wide area network (WAN), or storage area network (SAN), or a combination of these. These storage devices can connect to the device performing the embodiments of the present disclosure through an external port. Also, separate storage devices on the communication network can connect to the device performing the embodiments of the present disclosure.

In the specific embodiments of the present disclosure described above, components included in the disclosure were expressed in singular or plural form according to the specific embodiments presented. However, the singular or plural expression is chosen appropriately for the situation presented for ease of explanation, and the present disclosure is not limited to components in singular or plural form. Components expressed in the plural form may also be configured in singular form, and components expressed in the singular form may also be configured in plural form.

While the present disclosure has been described with reference to specific embodiments, various changes are possible within the scope of the present disclosure. Therefore, the scope of the present disclosure should not be limited to the described embodiments but should be determined by the appended claims and their equivalents.

What is claimed is:

1. A method of operating a user equipment (UE) in a wireless communication system, comprising:
transmitting capability information of the UE to a network;
receiving at least one of a structure or parameters of a reference model, or receiving a learning data set from the network according to the capability information of the UE;
configuring a machine learning (ML) model directly on the UE or through a UE-side learning server based on the received information; and
performing integrated inference based on dual-sided machine learning models with the network using the configured machine learning model,
wherein the capability information of the UE includes at least one of: whether inference using a reference machine learning model is possible, whether learning is possible, or whether a UE-side learning server is used.

2. The method of claim 1, wherein the at least one of the structure or parameters of the reference model, or the learning data set is directly received through higher layer signaling, or is indirectly received through an indicator.

3. The method of claim 1, wherein when configuring the machine learning model through the UE-side learning server, the method further comprises transmitting inference processing capability and storage space size information of the UE to the UE-side learning server.

4. The method of claim 1, further comprising:
notifying the network of the completion of reception of the received information,
wherein if the reception completion notification is not transmitted within a certain time, retransmission is performed from the network.

5. The method of claim 1, wherein configuring the machine learning model through the UE-side learning server comprises transmitting the received at least one of machine learning model structure or parameters, or learning data set to the UE-side learning server and requesting learning using this.

6. The method of claim 1, wherein receiving at least one of the structure or parameters of the reference model, or receiving the learning data set from the network comprises:
receiving an identifier instead of receiving the entire data, and configuring a model from the UE-side learning server using this.

7. The method of claim 1, wherein receiving at least one of the structure or parameters of the reference model, or receiving the learning data set from the network comprises:
additionally receiving one or more of: additional learning data sets, additional validation data sets, or validation target performance information.

8. A method of operating a network in a wireless communication system, comprising:
receiving capability information of a user equipment (UE) from the UE;
transmitting at least one of a structure or parameters of a reference model, or transmitting a learning data set to the UE or a UE-side learning server according to the capability information of the UE;
receiving machine learning model configuration completion information from the UE; and
performing integrated inference based on dual-sided machine learning (ML) models with the UE,
wherein the capability information of the UE includes at least one of: whether inference using a reference machine learning model is possible, whether learning is possible, or whether a UE-side learning server is used.

9. The method of claim 8, wherein the at least one of the structure or parameters of the reference model, or the learning data set is directly transmitted through higher layer signaling, or is indirectly transmitted through an indicator.

10. The method of claim 8, further comprising:
performing retransmission if a reception completion message for the transmitted information is not received within a certain time,
wherein if the retransmission repeatedly fails, it is determined that the delivery procedure has failed.

11. The method of claim 8, further comprising:
receiving learning results from the UE-side learning server when the machine learning model is configured through the UE-side learning server.

12. The method of claim 8, wherein when transmitting the structure and parameters of the reference model, information about required inference processing capability and storage space size is transmitted together.

13. The method of claim 8, further comprising:
transmitting a completion message for the delivery of machine learning model and parameter information to the UE after receiving the machine learning model configuration completion information.

14. A user equipment (UE) in a wireless communication system, comprising:
a transceiver; and
a controller operably connected to the transceiver,
wherein the controller is configured to transmit capability information of the UE to a network, receive at least one of a structure or parameters of a reference model, or receive a learning data set from the network according to the capability information of the UE, configure a machine learning (ML) model directly on the UE or through a UE-side learning server based on the received information, and perform integrated inference based on dual-sided machine learning models with the network using the configured machine learning model,
wherein the capability information of the UE includes at least one of: whether inference using a reference machine learning model is possible, whether learning is possible, or whether a UE-side learning server is used.

15. The UE of claim 14, wherein the at least one of the structure or parameters of the reference model, or the learning data set is directly received through higher layer signaling, or is indirectly received through an indicator.

16. The UE of claim 14, wherein the controller is further configured to transmit inference processing capability and storage space size information of the UE to the UE-side learning server when configuring the machine learning model through the UE-side learning server.

17. The UE of claim 14, wherein the controller is further configured to notify the network of the completion of reception of the received information, and if the reception completion notification is not transmitted within a certain time, retransmission is performed from the network.

18. The UE of claim 14, wherein the controller is configured to transmit the received at least one of machine learning model structure or parameters, or learning data set to the UE-side learning server and request learning to configure the machine learning model through the UE-side learning server.

19. The UE of claim 14, wherein the controller is configured to receive an identifier instead of receiving the entire data, and configure a model from the UE-side learning server using this to receive at least one of the structure or parameters of the reference model, or receive the learning data set from the network.
